(19) United States
(12) Patent Application Publication
(10) Pub. No.: US 2010/0328471 A1
(43) Pub. Date: Dec. 30, 2010

(54) Wearable Multi-Channel Camera

(76) Inventors: Justin Boland, Altadena, CA (US); John Michael Tamkin, San Marino, CA (US); Claude Tribastone, Webster, NY (US)

Correspondence Address: Davis Wright Tremaine LLP - Portland;William A. Birdwell, 1300 S.W. Fifth Avenue, SUITE 2300, Portland, OR, 97201-5630, US

(21) Appl. No.: 12/491,190

(22) Filed: Jun. 24, 2009

(51) Int. Cl. H04N 5/225

(52) U.S. Cl. 348/207.99; 348/E05.024

(57) ABSTRACT

A multi-channel camera system for capture of still or video images includes multiple fixed focal length lenses and multiple digital sensors in a compact package. A preferred embodiment of the invention is wearable, and is intended to be head-mounted near a user's eye to capture, in real time, the user's perspective view of a scene. The multi-channel lens system sub-assembly preferably includes three fixed focal length lenses—a wide angle lens, a standard lens, and a telephoto lens,—each providing a different field of view. Lens elements are arranged in a monolithic integrated structure, and optionally separated from each other by light-absorbing baffles to minimize cross-talk between the channels. The camera system includes circuitry to select one or more lenses, capture and compress a series of images, and transfer the images for storage on a remote device. Standard communication protocols may be used for wireless image data transfer.

### RELATED APPLICATIONS

The present patent application claims benefit of U.S. Provisional Patent Application No. 60/075,317, filed on Jun. 24, 2008.

### TECHNICAL FIELD

The embodiments of the present invention disclosed herein relate generally to the fields of digital imaging, multi-lens cameras, and wireless imaging systems, and specifically to devices that feature integrated optics.

### BACKGROUND

The replacement of film cameras with digital electronic cameras has revolutionized photography. The basic difference between a digital camera and a film camera is that a digital camera substitutes an electronic light sensor for the film. Both film and digital cameras employ lenses to focus an image onto an image plane, typically located at the camera “backplane,” at which the film or the electronic sensor records the focused image. Because film is a light-sensitive emulsion meant to be exposed in a controlled environment, use of multiple films within the same camera enclosure is generally impractical. In the past, this restriction limited the designs of traditional film cameras to those having a single optical axis. Restriction to a single optical axis dictates use of a single lens mounted in the optical path at any given time. Thus, photographers either had to swap lenses, or carry multiple camera bodies, each mounted with a different lens, in order to adjust the field of view of the camera.

Zoom lenses were developed to overcome this restriction, by extending a single optical path and thereby providing the flexibility of accessing multiple focal lengths within a single lens. A zoom lens thus enables close-up shots (telephoto) for magnification of far-away objects, or an increased field of view (wide angle) for capturing a panoramic scene, without the inconvenience of changing lenses. A zoom lens offers flexibility and convenience by including a greater number of optical elements than a fixed focal length compound lens, and by expanding and contracting to change relative distances between the optical elements. However, each zoom lens has a limited range, and the disadvantages compared to a fixed focal length lens become more severe as the range increases. A major disadvantage is that the additional optical elements in a zoom lens decrease the light intensity that reaches the image plane. Thus, the lens is “darker,” and the aperture must be held open longer at a given shutter speed in order to achieve adequate exposure. This tends to reduce the sharpness of the image, and precludes capturing high quality stop-action images of moving objects. A further disadvantage is that the combination of additional elements and moving parts for expansion and contraction of the optical path in a zoom lens tend to dramatically increase cost, increase weight, and reduce ruggedness and reliability.

With the advent of digital photography, the restriction to a single optical axis was lifted, providing an opportunity for even greater flexibility through the use of multi-lens camera designs. Despite this opportunity, many digital cameras currently in use continue to have only one optical axis, though they need not continue to be so restricted. Digital camera systems allow for multiple sensors and multiple fixed focal length lenses to be installed along multiple parallel paths within a common housing. A photographer using a digital camera may then electronically select a lens sub-assembly that is appropriate to capture a particular scene.

Thus, a multi-lens camera design using fixed focal length lenses allows retaining many of the advantages of a zoom lens without the drawbacks. Alternatively, a combination of fixed focal lengths and zoom lenses may be used in a multi-lens camera design. This concept is disclosed in a family of patents for digital cameras assigned to the Eastman Kodak Company that support multiple optical axes with multiple image sensors to provide an extended zoom range for still (non-video) photography. The Kodak patents include U.S. patent application Ser. No. 11/061,002, filed Feb. 18, 2005; U.S. patent application Ser. No. 11/060,845, filed Feb. 18, 2005; U.S. Pat. No. 7,305,180, filed Aug. 17, 2006; and U.S. Pat. No. 7,206,136, filed Feb. 18, 2005. However, the use of zoom lenses in such multi-channel systems continues to sacrifice image quality. Furthermore, both the lenses and the housings utilized in these systems have standard large-scale form factors i.e, the hand-held housing looks and feels like a traditional camera body, and each of the compound lenses is manufactured separately using discrete optical components. Finally, these and similar systems neglect to provide any capability for wireless communication of image data.

### SUMMARY

A wireless, remote, multi-channel camera system includes multiple fixed focal length lenses and multiple digital sensors in a compact package. The multi-channel camera system may be configured to support capture of still images or video images. A preferred embodiment of the invention is wearable, and is intended to be head-mounted near a user's eye to capture, in real time, the user's perspective view of a scene. In a preferred embodiment, the camera system is mounted in a standard BlueTooth™ cell phone headset. The multi-channel lens system sub-assembly preferably includes three fixed focal length lenses—a wide angle lens, a standard lens, and a telephoto lens,—each providing a different field of view. Lens elements are formed of transparent materials arranged in a monolithic integrated structure, and optionally separated from each other by light-absorbing baffles to minimize optical cross-talk between the multiple channels. The camera system includes control and processing circuitry to select at least one lens, capture and compress a series of images, and transfer the images for storage on a remote device. If multiple lenses are selected, a composite image may be formed from the multiple fields of view provided. The control and processing circuitry may be located either inside or outside the package enclosing the lens system sub-assembly. Electronic video compression enables wireless video data transfer via BlueTooth™ or other standard short-range communication protocols.

It is to be understood that this summary is provided as a means for generally determining what follows in the drawings and detailed description, and is not intended to limit the scope of the invention. Objects, features and advantages of the invention will be readily understood upon consideration of the following detailed description taken in conjunction with the accompanying drawings.

### BRIEF DESCRIPTION OF THE DRAWINGS

Embodiments of the present invention will be readily understood from the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a pictorial front view of an enclosure for packaging a wearable wireless multi-channel camera, according to a preferred embodiment, showing the position of the camera lens relative to a human eye.

FIG. 2 is pictorial top view of the enclosure for the wearable wireless multi-channel camera of FIG. 1.

FIG. 3 is a pictorial perspective view of three camera lenses mounted within the enclosure shown in FIGS. 1 and 2.

FIG. 4 is an optical layout diagram showing a preferred optical design comprising four-element lens arrangements for each of three compound lenses, having different focal lengths.

FIG. 5 is an exploded isometric view of an assembly of external and internal structural components comprising the multi-channel camera shown in FIGS. 1-3.

FIG. 6 is a simplified exploded isometric view of the assembly of FIG. 5 implemented with a 90-degree line-of-sight feature (an angled mirror or prism) that enables all three image sensors to be co-planar.

FIG. 7 is an optical layout diagram showing an alternative optical design in which a 90-degree line-of-sight feature is implemented with a prism.

FIG. 8 is an optical layout diagram showing an alternative optical design in which a 90-degree line-of-sight feature is implemented with an angled mirror.

### DETAILED DESCRIPTION OF EMBODIMENTS OF THE INVENTION

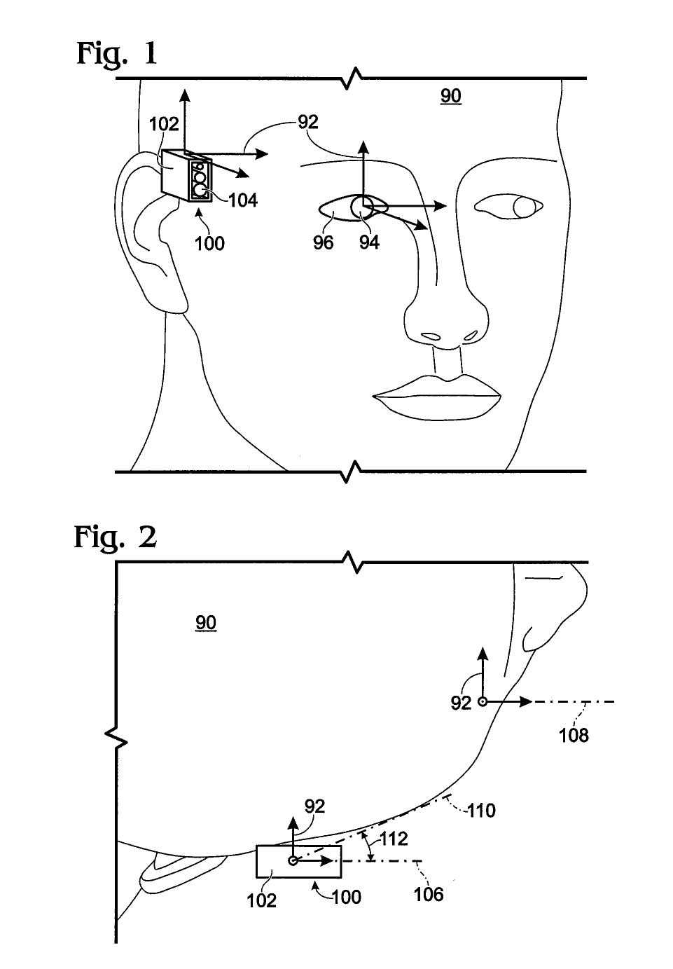

FIG. 1 shows a front view of a human head 90 representing a user, onto which is superimposed a system of three axes 92 centered on a pupil 94 of the user's eye 96. In general, the user may be a non-human being such as, for example, an animal, a bird, a fish, a machine, or a robotic vehicle equipped with machine vision that is capable of providing a view of a scene. To the left of the eye 96, near the temple, is a drawn-to-scale image of a multi-channel camera system 100 housed within a rectangular enclosure 102. A circle 104 tangent to the bottom side of enclosure 102 indicates the location of a representative lens. Axes 92 are again superimposed onto camera system 100 to indicate that the camera closely approximates the user's perspective view of a scene.

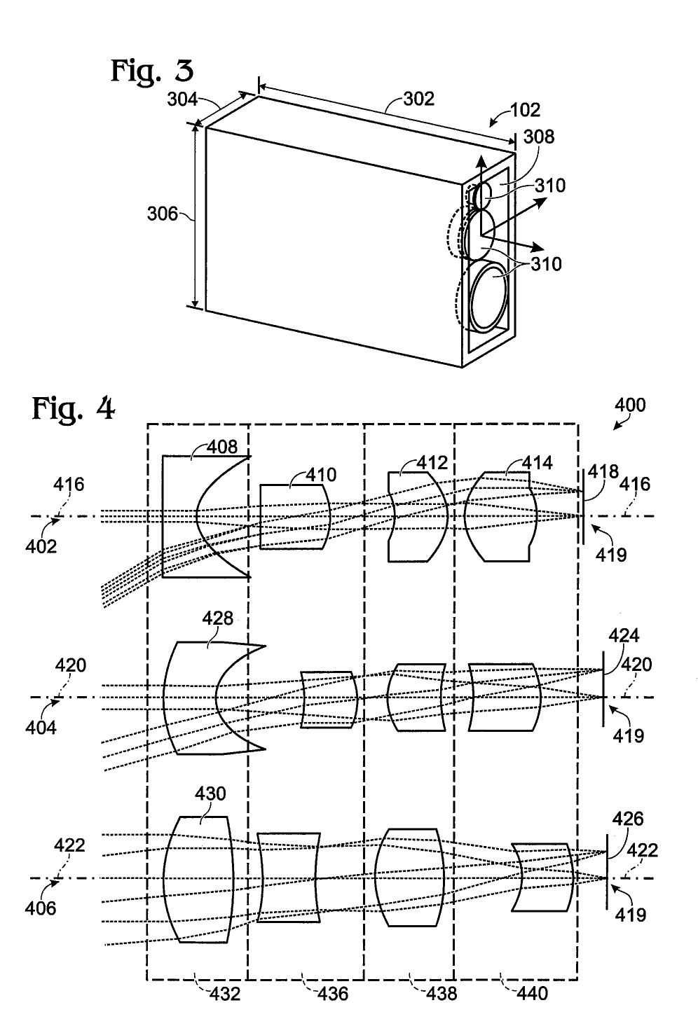

FIG. 2 shows a top-down view of human head 90 indicating a preferred position of camera system 100 with respect to the user's nose and ear. Enclosure 102 is again shown with axes 92 superimposed thereon. In addition, a line of sight axis 106 indicates the direction in which camera system 100 is aimed, shown here as substantially parallel to an optical axis 108 defining the user's corresponding line-of-sight. Furthermore, a tangent axis 110 indicates the maximum extent of an azimuthal angle 112 indicating the angular field of view of camera system 100 between optical axis 106 and the head 90, the angular field of view in one direction thus being partially obstructed by the head 90 in the present view. However, in general, camera system 100 may be shifted or rotated as described to match the perspective view of the user.

FIG. 3 shows a preferred enclosure 102 housing camera system 100. Enclosure 102 is preferably rectangular, having dimensions of length:width:height in a ratio of 3:1:2, for example, a package length 302 of about 15 mm, a package width 304 of about 5 mm, and a package height 306 of about 10 mm. Enclosure 102 delineates a common input surface 308 shared by front lens elements 310 of each of three optical channels.

In FIG. 4, a preferred custom optical design 400 is shown for implementing multi-channel camera system 100 as a three-lens system with video graphics array (VGA) resolution. FIG. 4 shows three separate channels corresponding to each of three fixed focal length, compound lenses, each channel providing a different field of view. A first channel 402, shown at the top of FIG. 4 provides a wide-angle full diagonal field of view of about 100 degrees; a second channel, 404, shown in the center of FIG. 4 provides a mid-range field of view of about 60 degrees; and a third channel, 406, shown at the bottom of FIG. 4, provides a narrow field of view of about 20 degrees. Overall focal lengths for each channel corresponding to the three fields of view are preferably about 1.5 mm, 2.2 mm, and 7.2 mm respectively. Defining the standard field of view to be 60 degrees wide, according to the usual convention, a 20 degree field of view would correspond to a 3× zoom; a 100 degree field of view would then be equivalent to a “negative 1.7× zoom.” An alternative embodiment may employ a more extreme range of focal lengths, for example, a fisheye lens may be used to provide an extremely wide field of view encompassing 120, 140, or even 180 degrees.

Each channel may be implemented as a compound lens having a unique arrangement of four different optical elements. For example, first channel 402 is implemented as a wide-angle compound lens having f 2.7, comprising a plano-concave lens element 408, followed by a plano-convex lens element 410, a concave-convex lens element 412, and finally a convex-convex lens element 414, each of which is aligned along a first optical axis 416. Light travels through the compound lens from left to right, for perpendicular incidence on a first image plane 418. Second and third channels 404 and 406, respectively, are arranged similarly, centered about respective second and third optical axes 420 and 422, to focus incident light onto respective second and third image planes 424 and 426.

Electronic image sensors 419 located at image planes 418, 424, and 426, and superimposed thereon, are preferably a digital CMOS VGA-compatible Bayer type sensor. Image sensor chips suitable for implementing optical design 400 may be obtained from Omnivision Technologies, Inc. of Santa Clara, Calif. According to a preferred embodiment, a set of three 7670 VGA sensors having 3.6 micron pixels is used to acquire images from each of the three optical channels. The area of each image detector is defined by a circle, about 3 mm in diameter, encompassing a 640×480 pixel array of CMOS sensors, the array having a pixel separation of 3.6 microns. The photo-optic response of the image sensors 419 is preferably about 465 nm-642 nm, thus covering most of the visible spectral range. Image sensors 419 are preferably covered by a Bayer filter, typically provided on consumer digital cameras, which filters colors so as to mimic the human eye, which is more attuned to color resolution properties of the center of the spectrum (yellow-green) than the ends of the spectrum (red or blue), All three sensor chips preferably reside on a common circuit board. Image sensor chips may be flexibly attached to the board using, for example, Flexcircuit™ cabling.

To provide a constant image resolution over the full range of optical and digital zoom, which may be called “continuous zoom,” a technique known as “digital down-sampling ” is used. Digital down-sampling is a new approach for integrating disparate lenses to create a nearly seamless experience for the user. To implement digital down-sampling, a zoom factor is determined by computing the ratio of the larger field of view to the smaller field of view of two disparate optical systems. Then the number of pixels recorded by the optical system having the smaller field of view is reduced to give the appearance of continuity. Some existing digital zoom features zoom in on an image at the expense of cropping the edges of the image. Thus they provide a smaller number of pixels in the final image. In contrast, the present technique uses a lower resolution over the entire range of digital zoom to maintain consistency. A lower limit for the resolution is set at the largest digital zoom factor for which the image is cropped. Then images having larger fields of view are down-sampled to provide the same resolution at a smaller magnification. This concept is desirable for an optical system with more than one optical path in which each optical path has a different field of view, but in which the user desires continuous zoom over the entire range without loss of perceived quality.

Rather than manufacturing lens elements 408-414 as discrete optical elements and mounting them in a traditional compound lens assembly constructed along the optical axis 416, lens elements 408-414 are formed within separate transparent structures that include the corresponding lens elements that are components of the other two channels 404, and 406. Thus, a convex-concave lens element 428 within second channel 404, and a convex-convex lens element 430 within third channel 406 are integrated within a common first transparent lens plate 432 that also contains lens element 408. Lens plate 432 is indicated by dotted lines.

A comprehensive 3×4 lens element matrix is thus formed by integrating corresponding lens elements that are parts of the first, second, and third channels 402-406, respectively, within second, third, and fourth transparent lens plates 436, 438, and 440, similar to first lens plate 432. Lens plates may be formed from optically transparent glass using precision glass molding techniques, or plastic using injection molding. In a preferred embodiment, lens plates 432, 438, and 440 are made of acrylic, and lens plate 436 is made of a polycarbonate material. The use of two different plastic materials enables correction of color aberrations within the optical system. Thus, all optical components may be formed of injection-molded plastic, so that the lens elements may be lightweight and shatter-proof. In an alternative embodiment, a material such as Ultem may be used, if necessary, to maximize thermal stability. To compensate for thickness variations introduced during the molding process, selected distances between plates may be maintained by spacer adjustment plates inserted between the lens plates.

It is important to note that lens elements common to each lens plate are generally not aligned with each other. The lens element positions are located along their respective optical axes 416, 420, and 422, at distances that yield a desired focal length, given the properties of the transparent materials, while maintaining a maximum depth of focus. This ensures that “focus adjustments” are not required for the three compound lenses. Thus, according to the preferred embodiment described herein, moving parts are not needed to focus the three lens systems, provided that the object is located a distance from the camera that is at least 0.5 m for the wide angle lens, and 3 m for the telephoto lens.

Adjacent lens plates 432-440 are substantially stationary, the plates assembled into a fixed, monolithic, interlocking structure. Such a monolithic structure may be assembled from the plates by snapping them together so as to establish a kinematic relationship using mechanical alignment features such as, for example, pins, holes, slots, or other such keys used for reliably and precisely attaching adjacent parts to lock them in place. Such a kinematic mount helps to ensure the relative lateral positions of the optical components are maintained as specified by preventing relative axial motion of the plates without over-constraining them and causing stress to the optics. Likewise, in a preferred embodiment, the positions of image planes 418, 424, and 426 may be staggered but still formed within a common structure. Such an integrated lens approach reduces the part count for building the lens matrix, from 12 individual optical elements to four lens plates, thereby reducing the cost of volume manufacturing by as much as 2-2.5 times compared to a traditional design that calls for building three separate and independent lens channels.

Custom-fabricated integrated lens structures suitable for applications such as those described above may be obtained from Apollo Optical Systems of Rochester, N.Y. A suitable design tool that may be used to define the system geometry and the lens characteristics needed for implementing such a multi-channel optical system is, for example, CODEV®, available from Optical Research Associates.

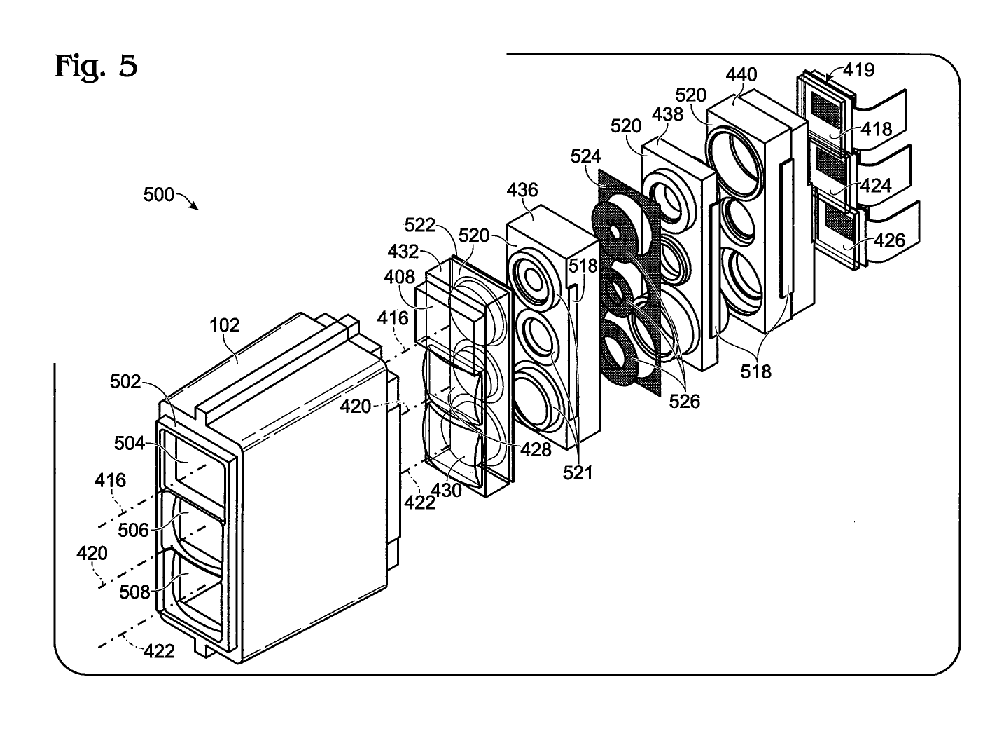

Referring to FIG. 5, an exploded assembly 500 shows exterior and interior details of enclosures 102 for a preferred embodiment that includes four lens plates, consistent with FIG. 4. A single baffle 524 is shown in detail in FIG. 5, and the edge of a second baffle 522 is also shown; however, FIG. 5 should be interpreted as general enough that it may represent a system having any sequence of baffles and lens plates. Light enters each of the compound lens systems corresponding to channels 402-406 through a front panel 502 in which three windows are inset. A first window 504 allows light to enter enclosure 102 and propagate along first optical axis 416; similarly, second and third windows 506 and 508 allow entrance and propagation of light along optical axes 420 and 422, respectively. Transparent lens plates 432, 436, 438, and 440 are shown, into which the 12 lens elements shown in FIG. 4 are integrated. Embedded rectangular lenses 408, 428, and 430 are shown pictorially in the drawing of first lens plate 432 in FIG. 5, and corresponding lenses are shown schematically in the drawings of second, third, and fourth lens plates 436, 438, and 440, to simplify the drawing for maximum visibility of other, non-optical, parts and features. For example, a front surface 520 of second lens plate 436 is configured with a cutout section 518 for mating with an interior bulkhead feature of enclosure 102 (not shown). Likewise, front surfaces 520 of each of the other lens plates, 436, 438, and 440, are equipped with protruding circumferential rings 521 that interlock with corresponding keyed circular holes formed in the back surfaces of the adjacent lens plates. In a preferred embodiment, it is the circumferential rings 521 that achieve the kinematic mount mentioned above.

After passing through first transparent lens plate 432, light within channel 402 is contained by a first light absorbing baffle 522, disposed between lens plates 432 and 436. First baffle 522 serves to minimize cross-talk between the three channels by absorbing, and thereby controlling, stray light. A second light-absorbing baffle 524 is similarly disposed in-between lens plates 436 and 438. Use of a third light-absorbing baffle was determined to be unnecessary during testing of the preferred embodiment shown, though one or more additional baffles may be provided without departing from the principles of the invention. Rings 521 extend through circular openings in baffles 522 and 524, the rings also serving to support three different aperture stops 526, one for each of the wide angle, mid-range, and telephoto lens fields of view. Aperture stops 526 function much like apertures in a conventional single lens reflex camera, but instead of being adjustable, their diameters are fixed at a pre-selected value. The f-number for each of the lenses is 2.8.

In addition, FIG. 5 offers a front perspective view of electronic image sensors 419, which are staggered along parallel optical axes 416-422 so as to vary their positions along the respective optical axes according to the focal lengths of the different lenses for each channel. Image sensors are preferably located at hyper-focal distances so that the images remain in focus and therefore moving parts for adjusting focus are unnecessary. In one alternative embodiment, image sensors 419 may be mounted on auto-focus micro-machined moveable stages, which may, in turn, be mounted on a single substrate such as a printed circuit board (PCB). The PCB then may be keyed to an adjacent lens plate to maintain image sensors 419 in fixed positions, while axial positioning of the stages perpendicular to the PCB independently adjusts the focus of each image.

Because image sensors 419 may crop images, there exist extra pixels, or “dark spaces” at the edges of the sensor that are not recorded. These dark spaces may be utilized to capture additional information. A preferred embodiment employs Electronic Image Stabilization (EIS), to sense movement of the camera by tracking differences in the edge pixels between one or more successive frames. Using EIS, the recorded image can dynamically track the field of view of interest by adjusting the cropped region of the sensor accordingly. Furthermore, the three sensors may each have a different resolution, allowing the system to shoot video at a lower resolution while still photographs may be shot at a high resolution. The frequency response of each of the three sensors may also be tuned to a different frequency range allowing, for example, one sensor to be a visible light sensor (e.g., 400 nm-700 nm), while a second sensor is tuned to the infrared (IR) range (e.g., 700 nm-1000 nm) to enable night vision.

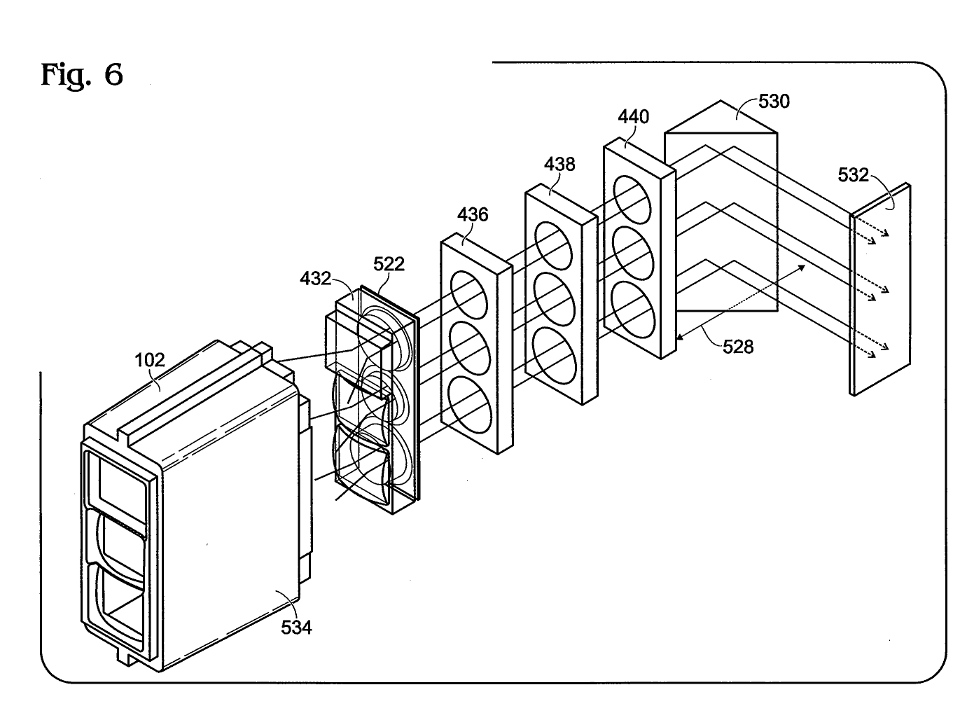

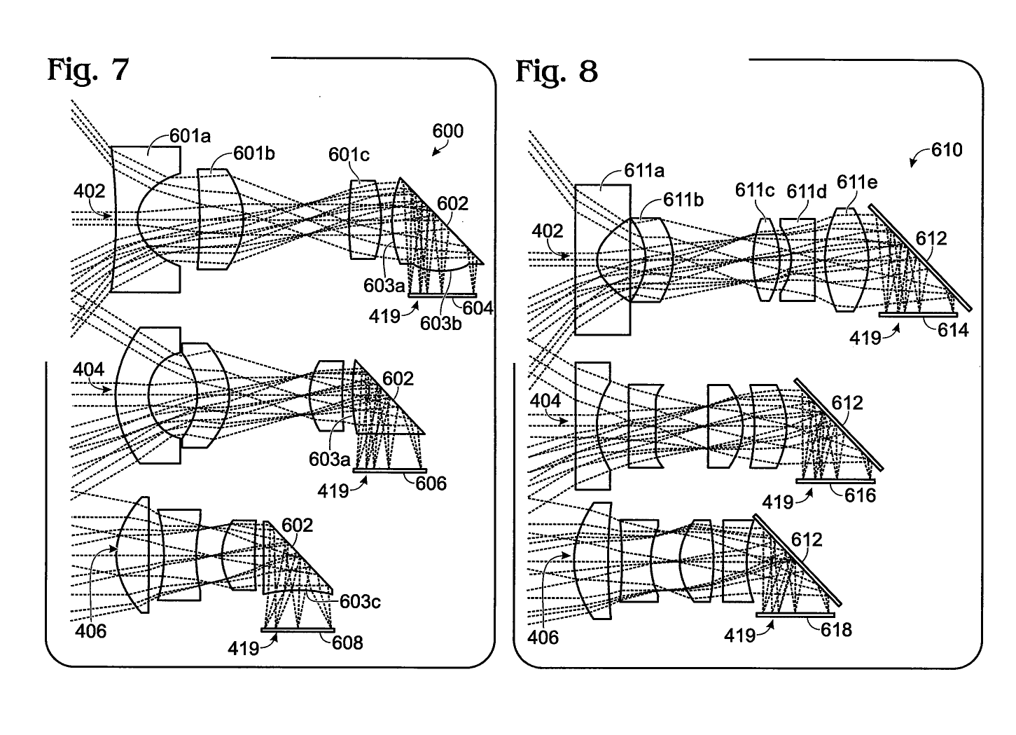

FIGS. 6-8 present further alternatives to optical design 400, that offer a “90 degree line-of sight (LOS)” feature. Referring to FIG. 6, a long back focal distance 528 accommodates an additional optical element 530 for folding multiple optical paths to direct light at a 90-degree angle toward a common sensor plane 532. Sensor plane 532 is generally parallel to a sidewall 534 of enclosure 102. FIG. 6 may also be viewed as a generic representation of an assembly that may configured with any number of lens plates and baffles, and in which various types of elements may be used as optical element 530, which provides the 90-degree LOS feature, according to different embodiments that employ different optical designs. In general, FIG. 6 shows that an advantage of including a 90-degree LOS feature is that it enables manufacturing, within a compact form factor, all three image sensors on a common PCB located at sensor plane 532 instead of in a staggered configuration. Such an embodiment further reduces the parts count, and consequently, the overall cost of camera system 100.

Whereas FIG. 6 generally indicates the alternative folded optical path, and the corresponding geometry of a camera system 100 having a 90-degree LOS feature, FIGS. 7 and 8 describe specific embodiments in which the additional optical element 530 may be either a prism or an angled mirror. In the first example, a fold prism alternative optical design 600, shown in FIG. 7, employs three integrated lens elements 601a, 601b, and 601c, and a prism 602, having one or more “powered” (i.e., curved) surfaces for adjusting the path length of first optical channel 402. For example, in the embodiment shown, first optical channel 402 employs prism 602 having two convex surfaces 603a and 603b. Analogous to optical design 400 shown in FIG. 4, the fold prism optical design 600 may also be manufactured by integrating corresponding lens elements within interlocking lens plates (omitted for clarity). In such an approach, the first and third lens plates are preferably made of acrylic, and the second lens plate is preferably made of polycarbonate. Prism 602, preferably made of acrylic, is inserted between third optical element 601 c and electronic image sensor 419 so as to direct light at a 90-degree angle for incidence at prism image plane 604 in place of the vertical image plane 418 shown in FIG. 4.

Second and third optical channels 404 and 406 comprise corresponding lens elements and prisms. Second optical channel 404 employs a prism 602 having one convex surface 603a, and third optical channel 406 employs a prism 602 having one concave surface 603c. Surfaces 603a-603c are designed so as to adjust the path lengths of the optical channels 402-406 to ensure that image planes 606 and 608 coincide with each other and with image plane 604. Thus, referring back to FIG. 6, if prism 602 is used as the optical element 530, light is directed at 90 degrees toward a common prism sensor plane 532 that may accommodate all three image sensors 419 in a vertical co-planar configuration.

In the second example, a fold mirror alternative optical design 610, shown in FIG. 8, employs five lens elements. 611a-611e, and an angled mirror 612 for each of the three channels 402-406. Again, manufacture of the design shown in FIG. 8 is accomplished by integrating corresponding lens elements within vertical interlocking lens plates (omitted for clarity), the second and fourth lens plates preferably made of acrylic, and the first, third, and fifth lens plates preferably made of polycarbonate. Angled mirror 612 is inserted between fifth optical element 611e and electronic image sensor 419 so as to direct light at a 90-degree angle for incidence at mirror image plane 614, in place of vertical image plane 418 shown in FIG. 4. Likewise, second and third mirror image planes 616 and 618 in fold mirror design 610 are substituted for the image planes 424, and 426 used in optical design 400. Thus, in FIG. 6, if angled mirror 612 is used as the optical element 530, light is directed at 90 degrees toward a common mirror sensor plane 533 that may accommodate all three image sensors 419 in a vertical co-planar configuration.

Although certain embodiments have been illustrated and described herein, it will be appreciated by those of ordinary skill in the art that a wide variety of alternative or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein.

The terms and expressions which have been employed in the foregoing specification are used therein as terms of description and not of limitation, and there is no intention, in the use of such terms and expressions, to exclude equivalents of the features shown and described or portions thereof, it being recognized that the scope of the invention is defined and limited only by the claims that follow.

1. A multi-channel imaging system for selecting and acquiring an image of a scene, comprising:
a plurality of lenses, each lens having a distinct optical axis, a plurality of optical elements distributed along its optical axis, a different focal length, and an electronic image sensor disposed at an image plane of the lens;
a controller for selecting at least one of the lenses as an image source; and
an electronic processor for capturing an image from at least one lens and providing an output signal representing that image, the lenses being disposed within an enclosure adapted to be worn on the head of a user so that images produced thereby approximate the perspective view of the user.

2. The system of claim 1, further comprising a wireless transmitter for transmitting the output signal.

3. The system of claim 1, further comprising a memory module for storing image information.

4. The system of claim 1, wherein the controller selects multiple lenses as image sources, and a composite image is formed from the respective output signals corresponding to the multiple lenses.

5. The system of claim 1, wherein the electronic image sensors are co-planar.

6. The system of claim 1, wherein at least one of the electronic image sensors is mounted on a moveable stage.

7. The system of claim 1, wherein at least one of the electronic image sensors is disposed at a hyper-focal distance.

8. The system of claim 1, wherein each of the lenses has a different field of view.

9. The system of claim 8, wherein the lenses having different fields of view include a telephoto lens, a wide angle lens, and a normal lens of intermediate field of view.

10. The system of claim 1, wherein optical elements from at least two lenses are formed in a lens plate made of optical material, each lens plate being common to at least those two lenses.

11. The system of claim 10, further comprising additional lens plates made of optical material in which optical elements from at least two lenses are formed, each lens plate being common to at least those two lenses.

12. The system of claim 11, wherein the lens plates have substantially flat surfaces.

13. The system of claim 11, wherein the optical material is glass.

14. The system of claim 11, wherein the optical material is a substantially transparent plastic.

15. The system of claim 14, wherein the transparent plastic is polycarbonate.

16. The system of claim 14, wherein the transparent plastic is acrylic.

17. The system of claim 11, wherein the lens plates are formed using a molding process.

18. The system of claim 17, wherein the molding process is injection molding.

19. The system of claim 17, wherein the molding process is precision glass molding.

20. The system of claim 17, wherein the molding process is stamping.

21. The system of claim 11, wherein multiple lens plates are spaced apart at selected distances along an optical axis.

22. The system of claim 11, wherein the optical elements are positioned by a kinematic mount.

23. The system of claim 21, wherein the selected distances are maintained by spacer adjustment plates inserted between the lens plates, the adjustment plates compensating for thickness variations introduced during the molding process.

24. The system of claim 11, wherein some of the multiple lens plates are separated by light-absorbing baffles.

25. The system of claim 11, wherein the plurality of optical elements includes an additional optical element that directs light toward an image plane oriented substantially parallel to the optical axis.

26. The system of claim 25, wherein the additional optical element is a prism.

27. The system of claim 25, wherein the additional optical element is a mirror.

28. A multi-channel imaging system for selecting and acquiring an image of a scene, comprising:
a plurality of lenses, each lens having a distinct optical axis, a plurality of optical elements distributed along its optical axis, a different focal length, and an electronic image sensor disposed at an image plane of the lens, optical elements of at least two lenses being formed in a common lens plate of optical material;
an electronic processor for capturing an image from at least one lens so as to be available as an output signal; and
an enclosure in which the plurality of lenses are disposed.

29. The system of claim 28, further comprising a memory module for storing image information.

30. The system of claim 28, further comprising a wireless transmitter for transmitting the output signal.

31. The system of claim 28, wherein at least one image sensor is disposed at a hyper-focal distance from the lens.

32. The system of claim 28, further comprising a controller that selects multiple lenses as image sources, so that a composite image may be formed from the respective output signals corresponding to the multiple lenses.

33. The system of claim 28, wherein the electronic image sensors are co-planar.

34. The system of claim 28, wherein at least one of the electronic image sensors is mounted on a moveable stage.

35. The system of claim 28, wherein at least one of the image sensors is disposed at a hyper-focal distance from the lens.

36. The system of claim 28, wherein each of the lenses has a different field of view.

37. The system of claim 36, wherein the lenses having different fields of view include a telephoto lens, a wide angle lens, and a normal lens of intermediate field of view.

38. The system of claim 28, further comprising additional lens plates made of optical material in which optical elements from at least two lenses are formed, each lens plate being common to at least those two lenses.

39. The system of claim 38, wherein the lens plates have substantially flat surfaces.

40. The system of claim 38, wherein at least two adjacent lens plates are separated by light-absorbing baffles.

41. The system of claim 38, wherein the optical material is glass.

42. The system of claim 38, wherein the optical material is a substantially transparent plastic.

43. The system of claim 42, wherein the plastic is polycarbonate.

44. The system of claim 42, wherein the plastic is acrylic.

45. The system of claim 38, wherein the lens plates are formed using a molding process.

46. The system of claim 45, wherein the molding process is injection molding.

47. The system of claim 45, wherein the molding process is precision glass molding.

48. The system of claim 45, wherein the molding process is stamping.

49. The system of claim 38, wherein multiple lens plates are spaced apart at selected distances along an optical axis.

50. The system of claim 49, wherein the selected distances are maintained in a kinematic mount by mechanical alignment features.

51. The system of claim 49, wherein the selected distances are maintained by spacer adjustment plates inserted between the lens plates to compensate for thickness variations introduced during the molding process.

52. The system of claim 38, wherein the plurality of optical elements includes an additional optical element that directs light toward an image plane oriented substantially parallel to the optical axis.

53. The system of claim 52, wherein the additional optical element is a prism.

54. The system of claim 52, wherein the additional optical element is a mirror.

55. A method of acquiring an image of a scene, the method comprising:
providing, within an enclosure adapted to be worn on the head of a user, a multi-channel optical system having a plurality of lenses, each lens containing a plurality of optical elements, and each lens having a different focal length and an associated electronic image sensor; and
switching electronically between image sensors so as to select image information from at least one of the lenses, thereby approximating the perspective view of the user.

56. The method of claim 55, further comprising wirelessly transmitting the selected image information.

57. The method of claim 55, further comprising storing the selected image information.

58. The method of claim 55, further comprising forming a composite image from image information selected from multiple lenses.

59. The method of claim 55, further comprising compensating for movement of the lenses by electronic image stabilization.

60. The method of claim 55, wherein approximating the perspective view of the user comprises providing continuity of image resolution by digital down-sampling.

61. The method of claim 55, wherein the plurality of lenses includes a telephoto lens, a wide angle lens, and a normal lens of intermediate field of view.

62. The method of claim 55, further comprising focusing the image by moving the image sensor relative to the lens.

63. The method of claim 55, further comprising placing the image sensor at a hyper-focal distance away from the lens.

64. A multi-channel imaging system for selecting and acquiring an image of a scene, comprising:
a plurality of lenses, each lens having a distinct optical axis, a plurality of optical elements distributed along its optical axis, a different field of view, and an electronic image sensor disposed at an image plane of the lens;
a controller for selecting at least one of the lenses as an image source; and
an electronic processor for capturing an image from at least one lens and providing an output signal representing that image, the lenses being disposed within an enclosure adapted to be worn on the head of a user so that images produced thereby approximate the perspective view of the user.

65. The system of claim 64, wherein the lenses having different fields of view include a telephoto, a wide angle, and a normal lens of intermediate field of view.

66. The imaging system of claim 64, wherein the electronic processor performs digital down-sampling to provide continuity of image resolution.

67. A multi-channel imaging system for selecting and acquiring an image of a scene, comprising:
a plurality of lenses, each lens having a distinct optical axis, a plurality of optical elements distributed along its optical axis, a similar field of view, and an electronic image sensor disposed at an image plane of the lens where different optical channels have been optimized for different spectral ranges;
a controller for selecting at least one of the lenses as an image source; and
an electronic processor for capturing an image from at least one lens and providing an output signal representing that image.
